(19) United States
(12) Patent Application Publication
(10) Pub. No.: US 2013/0345945 A1
(43) Pub. Date: Dec. 26, 2013

(54) METHOD FOR IMPLEMENTING AN ENERGY MANAGEMENT OF A VEHICLE

(71) Applicants: Uta FISCHER, Gerlingen (DE); Udo SCHULZ, Vaihingen/Enz (DE)

(72) Inventors: Uta FISCHER, Gerlingen (DE); Udo SCHULZ, Vaihingen/Enz (DE)

(73) Assignee: ROBERT BOSCH GMBH, Stuttgart (DE)

(21) Appl. No.: 13/926,477

(22) Filed: Jun. 25, 2013

(30) Foreign Application Priority Data
Jun. 25, 2012 (DE) 10 2012 210 698.7

(51) Int. Cl. F02D 45/00

(52) U.S. Cl. CPC F02D 45/00
USPC 701/102

(57) ABSTRACT

A method for implementing an energy management of a vehicle which is movable via an electric drive, the electric drive being able to be driven by electrical energy stored in an electrical energy store, the method including: inputting a destination; and searching for a route to the destination, on which an available electrical energy source able to be used to recharge the electrical energy store is available within a minimum distance; the minimum distance corresponding to a path along which the vehicle is minimally still able to drive using the energy stored in the electrical energy store.

### CROSS REFERENCE

The present application claims the benefit under 35 U.S.C. §119 of German Patent Application No. DE 102012210698.7 filed on Jun. 25, 2012, which is expressly incorporated herein by reference in its entirety.

### FIELD

The present invention generally relates to vehicles, especially vehicle diagnosis systems for vehicles. In addition, the present invention relates to the energy management of a battery for driving a vehicle equipped with the battery.

### BACKGROUND INFORMATION

It is common knowledge that the driving of electric vehicles requires electrical energy, which currently is provided by an electrical energy store that must be charged with electrical energy in advance.

### SUMMARY

According to a first aspect of the present invention, an example method for implementing an energy management of a vehicle which is movable via an electric drive is provided, and the electric drive is able to be driven using electrical energy stored in an electrical energy store. The method comprises the following:
inputting a destination; and
searching for a route to the destination, on which an available electrical energy source which may be used to recharge the electrical energy store is located within a minimum distance;
the minimum distance corresponding to a route that the vehicle is minimally still able to drive, using the energy stored in the electrical energy store.

The indicated example method is based on the idea that the recharging of modern electrical energy stores, such as lithium-ion batteries, can be very time-consuming and take several hours. For example, the electromotive drive of electric vehicles may use high-voltage batteries, which can be charged only in a narrow temperature range due to the cell technology used, and therefore require a corresponding thermo-management to heat or cool the high-voltage battery.

Furthermore, the indicated example method is based on the notion that the long charge period of electrical energy stores of electric vehicles certainly influences the acceptance of electric vehicles on the market, since it is quite difficult for a driver of the electric vehicle to arrive at a reasonable estimate of the time required for the routes to be traveled, even if the driver were to have knowledge of the range of an electrical energy store charge. The uncertainties of the availability of charge stations for the electrical energy store as far as times and locations are concerned, and the required time for charging the electrical energy store are simply too great. For example, as a result of the long charging times and thin charging infrastructure, bottlenecks with regard to unoccupied charge stations as well as charge times are possible, presuming that the electrical energy stores may, or need, not be charged only in the own garage/parking space, if available in the first place.

In accordance with the present invention, recent developments with regard to adaptive operating strategies, e.g., planning a vehicle route based on recognizing previously traveled routes, and with regard to predictive operating strategies, e.g., planning a vehicle trip using a navigation system, which allow better utilization of the degrees of freedom as a function of the vehicle topology with regard to consumption or energy savings, are able to be utilized for an energy management in electric vehicles as well. Via the timely discharge of stores so as to better utilize future recuperation potentials, and via the timely recharging of stores to allow operating points of consumers to be shifted into efficiency-optimal ranges in the future, it is also possible to make preparations for the time-consuming charging of the electrical energy stores, which provides relief and assistance to the driver.

In one further refinement, the method includes the following steps:
calculating an arrival time at the electrical energy source; and
reserving the electrical energy source for a charging period of the electrical energy store;
the electrical energy store being an energy source that is able to be shared by a plurality of users and can be reserved for the charging period in order to recharge the electrical energy store.

Due to the thin infrastructure of charge stations for the electrical energy stores of an electric vehicle, it should be assumed that the overall time requirement may be increased not only by the charge time of the electrical energy store itself, but also by the waiting time after arrival at the charge station until it is vacated by a previous user. However, this waiting time is able to be shortened in intelligent manner if the charge station is reserved for the electric vehicle ahead of time by determining a range and time of arrival, so that the waiting time is shortened for the driver of the electric vehicle; in addition—given a reverse information flow—other drivers of different electric vehicles are likewise able to be informed of the availability of the charge station, so that they can bypass it by using other routes that provide alternative charge stations, as the case may be.

In another further refinement, the method includes the following steps:
calculating an overall driving time based on the charging period and the travel time for the route.

Such information not only aids the driver in planning his route more precisely, but also lowers people's reservations about coming into contact with the technology of electric vehicles.

In one additional further refinement, the method includes:
calculating the charge duration based on an electrical energy requirement for moving the vehicle between the electrical energy source and the destination.

This further refinement is based on the reasoning that the time-consuming recharging of the electric vehicle need not necessarily be concluded completely if the remaining route lying ahead does not require the full but merely a portion of the capacity of the electrical energy store. This makes it possible to reduce the charging time of the electric vehicle to a minimum, which ultimately lowers the total driving time for the vehicle. Complete recharging of the electrical energy store, for example, may then take place at the destination, when the electric vehicle is parked for a mostly indeterminate time.

In an additional further refinement, the method includes:
querying an availability time, at which the energy source for shared use by multiple users is available to recharge the electrical energy store; and
calculating a suitable starting time based on the queried availability time and a driving time to the energy source able to be shared by a plurality of users.

The availability time indicates to the vehicle a time as of which the vehicle should not be driven so that recharging of electrical energy may take place, i.e., no electrical energy should be consumed as of this instant. This makes it possible to minimize the waiting time of the driver at a charge station, which ultimately shortens the total driving time for the vehicle.

In one special further refinement, the method includes:
querying an availability period during which the energy source for shared use by multiple users is available for recharging the electrical energy store,
the availability period of the energy source for shared use by multiple users on the searched for route to the destination at least having to be long enough to allow the electrical energy store to be recharged for a remaining distance to the destination or for an intermediate distance to another electrical energy source.

The availability period indicates a period during which the vehicle should not be driven in order to recharge electrical energy, i.e., no electrical energy should be consumed starting from this time. This further refinement is based on the notion that the potential charge period of the electrical energy store provided by the availability period depends also on the time-wise availability of the corresponding charge station. In terms of time, for example, this availability may depend on the opening hours of the operator of the charge station and/or the occupancy of the charge station by drivers of other electric vehicles. If the available charging period for the electric vehicle is too short, so that further recharging is necessary on the way to the destination, which may even be impossible in the worst-case scenario due to the lack of other charge stations, the particular route should not be chosen and another route, possibly an even longer one that provides available charge stations, should be selected instead.

In one preferred further refinement, the method includes:
querying a scheduled non-moving period of the vehicle at the electrical energy source;
selecting a charge strategy for charging the electrical energy store, based on the scheduled non-moving period.

The further refinement is based on the idea that while rapid charge concepts for charging electrical energy stores of electric vehicles do indeed exist, these rapid charge concepts reduce the service life and the capacity of the electrical energy store, in some cases considerably. However, the vehicle driver may have reasons for a longer stay when recharging the electrical energy store, for instance because a stay at a hotel for an overnight stay is intended at the same time. Rapid recharging and thus stressing of the electrical energy store are not required under these circumstances.

In one especially preferred further refinement, an operating behavior of the vehicle and/or external influences on the vehicle are/is taken into account in the route search.

This further refinement is based on the thought that the electrical energy consumption for the purpose of propelling the electric vehicle depends on environmental and driving conditions to which the electric vehicle is, and will be, exposed. During uphill travel and in the presence of strong headwinds, for instance, the electrical energy consumption may increase, while it may drop correspondingly during downhill travel and in the presence of strong tailwinds. The driving behavior of the driver itself also affects the electrical energy consumption, because when the driver brakes frequently and strongly and then accelerates, the electrical energy consumption will increase.

According to another aspect, a control device is provided, which is set up to implement the indicated method. The described device is expandable as desired such that it is able to execute one of the indicated methods according to the dependent claims.

In one further refinement of the present invention, the described device has a memory and a processor. The described method is stored in the memory in the form of a computer program, and the processor is provided to implement the method when the computer program is loaded from the memory into the processor.

According to another aspect of the present invention, a vehicle is equipped with a described device.

The present invention also relates to a computer program having program code for executing all of the steps of the indicated example method when the computer program is running on a computer or on one of the indicated devices.

In addition, the present invention also relates to a computer program product, which includes program code which is stored on a computer-readable data carrier and implements one of the above methods when it is executed on a data processing device.

### BRIEF DESCRIPTION OF THE DRAWINGS

Preferred embodiments of the present invention are explained in greater detail below with reference to the figures.

FIG. 1 shows a schematic representation of an electric vehicle traveling on a road.

FIG. 2 shows a schematic illustration of the vehicle of FIG. 1 together with a control device.

FIG. 3 shows a flow chart of a method executed in the control device of FIG. 2.

### DETAILED DESCRIPTION OF EXAMPLE EMBODIMENTS

Elements having the same or a comparable function have been provided with the same reference numerals in the figures and are described only once.

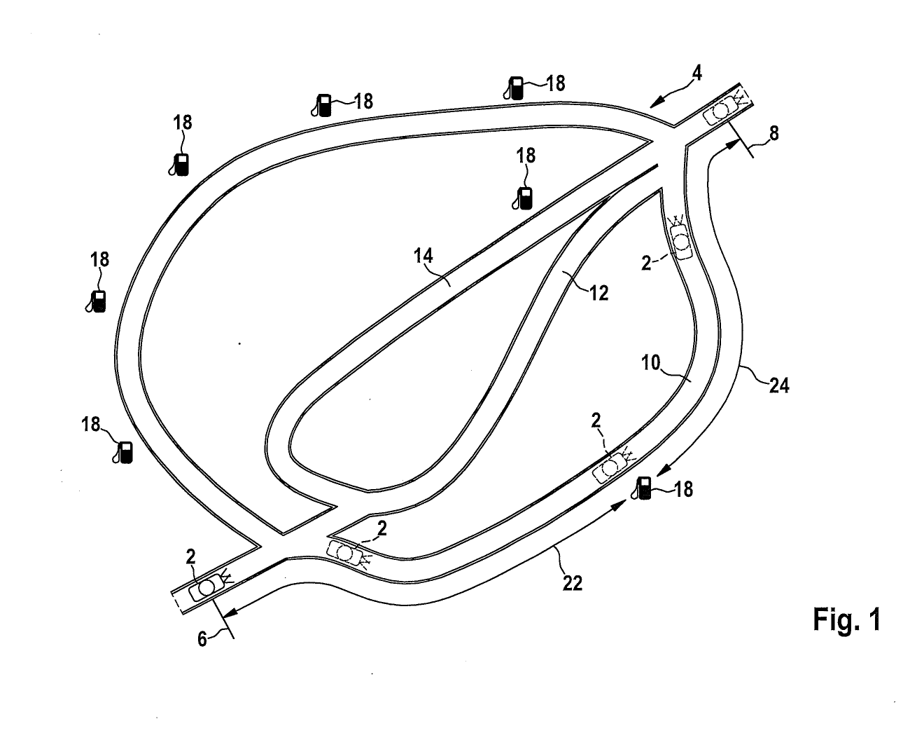

Reference is made to FIG. 1, which provides a schematic representation of an electric vehicle 2 on a road 4.

It is planned to move electric vehicle 2 from a starting position 6 to a destination position 8. In order to reach destination position 8 from starting position 6, road 4 has four different routes 10, 12, 14, 16 in the development at hand.

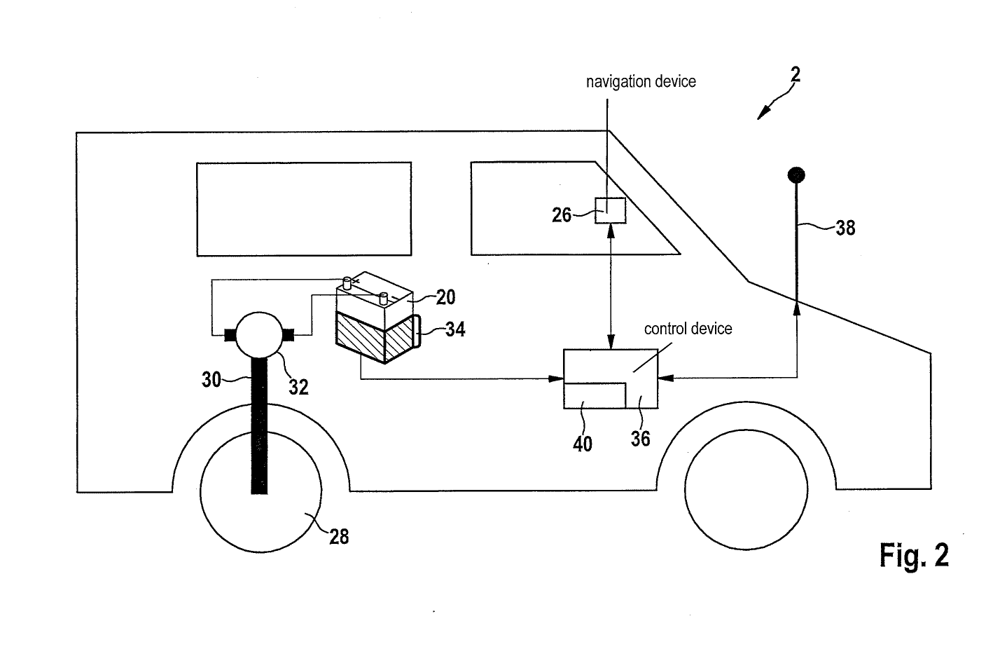

While a separate charge station 18 for charging an electrical energy store 20 of electrical vehicle 2 shown in FIG. 2 is available on first route 10 and third route 14, no charge station 18 at all is available on second route 12. In contrast, a total of five charge stations 18 are available on fourth route 16.

In the present development it should furthermore be assumed that second route 12 between starting position 6 and destination position 8 is the shortest. In ascending order, the length of the routes then rises from third route 14 via first route 10, to fourth route 16.

Finally, it should be assumed in the present development that charge station 18 on third route 14 is farthest away from starting position 6, whereas the distance of first charge station 18 on fourth route 16 to starting position 6 is the shortest. The distance, the interval, or the route between charge station 18 on first route 10, to starting position 6 is shorter than on third route 14, but longer than on fourth route 16. The distances between individual charge stations 18 on fourth route 16 should be assumed to be generally the same to the distance of first charge station 18 to starting position 6. As far as the individual distances of charge stations 18 from each other or from starting position 6 are concerned, only distance 22 between starting position 6 and charge station 18 is indicated on first route 10 and provided with a reference numeral, for reasons of clarity. A remaining distance 24 is left from charge station 18 on first route 10 to the destination position.

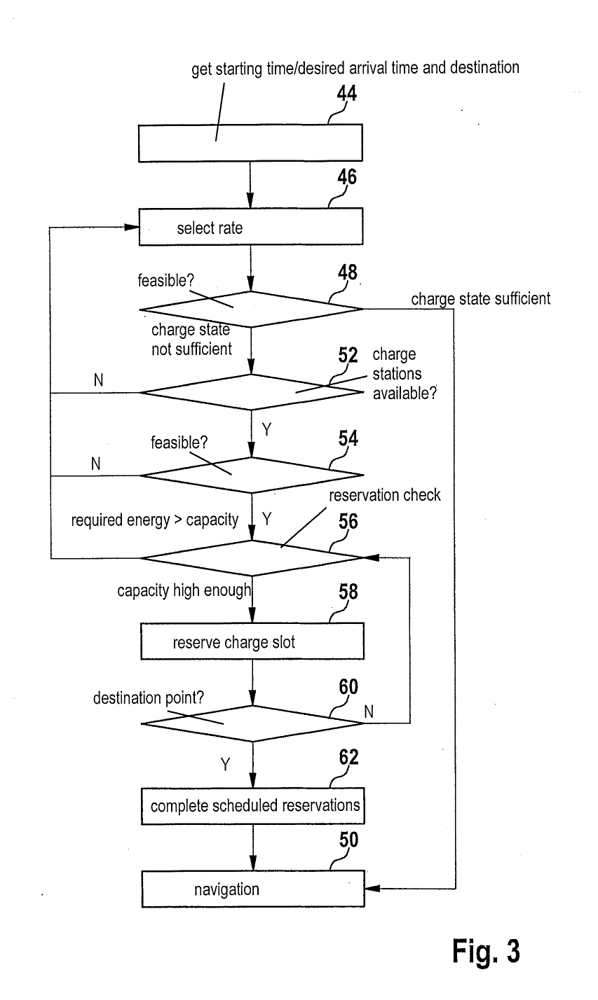

A navigation device 26 sketched in FIG. 2 is able to select one of the four routes 10 through 16 and guide the driver of electric vehicle 2 across the selected route from starting position 6 to destination position 8. In the present example embodiment, it is to be assumed that navigation device 26 has selected first route 10, which is indicated by electric vehicle 2, sketched by dashed lines, on first route 10. The details regarding the selection of first route 10 will be addressed in the further text with the aid of FIG. 3.

To begin with, electric vehicle 2 will be described in greater detail using FIG. 2.

Electric vehicle 2 has a rear wheel 28, which is driven by an electric motor 32 via a sketched shaft 30. Electric motor 32 itself is supplied with electrical energy via electrical energy store 20.

Electrical energy store 20 has a charge state 34 which is able to be read out by a control device 36. The readout of a charge state 34 of an electrical energy store 20 depends on the type of electrical energy store 20 and is known to one skilled in the art. For example, charge state 34 of a lithium-ion accumulator as electrical energy store may be ascertained based on its idling voltage; however, this will not be discussed here in greater detail.

Control device 36 may be part of navigation device 26 or a separate component in vehicle 2 and make said selection of route 10 through 16 to be traveled between starting position 6 and destination position 8. To do so, depending on the design, control device 36 may receive the route data from navigation device 26 or determine the data itself in the known manner based on GPS signals received via an antenna 38.

Using antenna 38, control device 36 preferably may transmit and receive additional data, which will be discussed in greater detail in the further text.

In addition, control device 40 includes a receiver interface to which different sensors are able to be connected, which will likewise be discussed in more detailed manner hereinafter.

Reference is made to FIG. 3, which illustrates a flow chart 42 of a method executed in control device 36 of FIG. 2.

Method 42 starts out with an input step 44, in which control device 36 requests from the driver of the electric vehicle the desired starting time at starting position 8 and/or the desired time of arrival at destination position 8, as well as destination position 8 itself. As an alternative, control device 36 could read out the starting time from an internal timer when setting off from start position 6. In the input step, control device 36 may query additional relevant data for the trip between starting position 6 and destination position 8 with the electric vehicle, such as traffic data via a traffic message channel, abbreviated TMC.

In a route-selection step 46, which follows input step 44, control device 36 selects one of routes 10 through 16 in a conventional manner, taking additional marginal conditions into account, as it is done in a conventional navigation system.

Among the marginal conditions could be bypassing of a traffic jam, bypassing of a toll road, or the specific input of detour points by the driver of electric vehicle 2. The selected route of routes 10 through 16 may be provided by navigation device 26 as well. However, part of the marginal conditions may also be that a particular route from among potential routes 10 through 16 is blocked.

In the present development it should be assumed that control device 36 has selected second route 12, since it is the shortest route. In a feasibility check 48 following the route-selection step 46, control device 36 checks whether charge state 34 of electrical energy store 20 is sufficient to travel the entire length of the selected (second) route. Various criteria may be considered in feasibility check 48. For example, control device 36 may detect a driving behavior of the driver of electric vehicle 2 via interface 40 and calculate the electrical energy consumption based on the driver's driving behavior and other wishes of the driver that are relevant in the energy context, such as climate control or infotainment. It is also possible that control device 36, via interface 40, acquires data in connection with a headwind and other marginal conditions that increase the energy consumption, so-called driving resistances, from an airflow sensor, and takes these into account in feasibility check 48. It may also be possible to deduct a safety margin from the drivable route determined within the framework of feasibility check 48.

If the result of feasibility check 48 indicates that the route able to be traveled at charge state 34 of electrical energy store 20 is sufficient to cover the selected route (second route 12), then the driver of electric vehicle 2 will be guided across the selected route to destination position 8 in a known manner in a navigation step 50.

In the development at hand, it should be assumed that charge state 34 of electrical energy store 20 is not sufficient for complete coverage of second route 34.

If it turns out that charge state 34 is insufficient to travel the selected route (second route 12), then control device 36 checks in an availability step 52 whether charge stations 18 are available along the path to destination position 8 on the selected route (second route 12). Since this is not the case in this instance, control device 36 would return to route-selection step 46 in the method, under the assumption that second route 12 may no longer be selected.

Let it be assumed in the newly executed route-selection step 46 that the control device selects third route 14 and returns with third route 14 to availability step 52, which now will be approved since a charge station 18 is available on third route 14.

In a second feasibility step 54, control device 36 checks whether charge state 34 of electric energy store 20 would even be sufficient to allow electric vehicle 2 to cover the distance to next charge station 18 on third route 14. In the development discussed, it should be assumed that charge state 34 of electrical energy store 20 would not be adequate to travel third route 14, which is why control device 36 would execute method 42 anew by step 46 under the assumption that second and third route 12, 14 will not be selected.

It should be assumed that a new execution of route-selection step 46 leads to first route 10, whereupon second feasibility step 54 is run through successfully as well, because distance 22 to charge station 18 on first route 10 is able to be traveled at charge state 34 of electrical energy store 20.

In a reservation check step 56, a check then takes place as to whether and for how long electric vehicle 2 is able to be charged at charge station 18 on first route 10. To do so, a time of arrival at charge station 18 is ascertained based on the starting time recorded within the framework of input step 44, and charge state 34 of electrical energy store 20 expected to be available at charge station 18 is checked. Next, it will be ascertained how much electrical energy is required to travel distance 24 to destination position 8 or, alternatively, a distance to a next charge station 18, and whether this electrical energy exceeds the capacity of electrical energy store 20. If the required electrical energy exceeds the capacity of electrical energy store 20, first route 10 would be blocked in reservation check step 56 and route-selection step 46 executed once again.

However, it should be assumed that the capacity of the electrical energy store is high enough to travel distance 24 to destination position 8. It would then still be ascertained in reservation check step 56 how much electrical energy is required to travel distance 24 to destination position 24 or, alternatively, to next charge station 18. A certain buffer may be added to this required energy in order to take the uncertainty of the prognosis into account. In the process, the required electrical energy may be calculated based on the same marginal conditions that had already been used in first feasibility step 48, so that it may be determined whether the first distance, from starting position 6, to next charge station 18 or to destination position 8, is able to be traveled. Next, based on the required electrical energy, the electrical energy still to be charged into electrical energy store 20 will then be determined, which is obtained from the difference between the required electrical energy and residual charge state 34 to be expected in electrical energy store 20 at charge station 18. Finally, it is determined how long it will take at charge station 18 to charge electrical energy store 20 with electrical energy and whether a free charge slot is even available at charge station 18 as of the estimated time of arrival. If this is answered in the affirmative, control device 26 reserves the charge slot at charge station 18 in step 58 for the calculated times. In the other case, it checks how long it will take until a charge slot becomes available at charge station 18. If this time is too long, then route-selection step 46 may be repeated.

Let it be assumed that a charge slot at charge station 18 is available at the calculated times, and that the reservation of the charge slot in step 58 has been scheduled. In step 60, control device 26 then checks whether the drive that starts at current charge station 18 ends at destination position 8. If the answer is yes, control device 26 completes all scheduled reservations in step 62 and selects second route 10, as indicated in FIG. 1.

If the answer is no, so that another charge station 18 has to be approached by newly recharged electrical energy store 20, then control device 26 returns to reservation-check step 56 and ascertains whether charge station 18 to be approached next would be available and makes another reservation. This process may be repeated until all required charge stations 18 have been booked along the route to be traveled.

What is claimed is:

1. A method for implementing an energy management of a vehicle movable via an electric drive, the electric drive being able to be driven by electrical energy stored in an electrical energy store, the method comprising:
specifying a destination; and
searching for a route to the destination on which an available electrical energy source which may be used to recharge the electrical energy store is available within a minimum distance, the minimum distance corresponding to a path which the vehicle is minimally still able to drive, using the energy stored in the electrical energy store.

2. The method as recited in claim 1, further comprising:
calculating an arrival time at the electrical energy source; and
reserving the electrical energy source for a charge period of the electrical energy store, the electrical energy source being an energy source which is able to be shared by a plurality of users and able to be reserved for recharging of the electrical energy store for a charge duration.

3. The method as recited in claim 2, further comprising:
calculating an overall driving time based on the charge duration and a driving time for the route.

4. The method as recited in claim 2, further comprising:
calculating the charge duration based on an electrical energy requirement for moving the vehicle between the electrical energy source and the destination.

5. The method as recited in claim 2, further comprising:
querying an availability time at which the energy source for shared use by multiple users is available for recharging the electrical energy store; and
calculating a suitable starting time based on the queried availability time and a driving time to the energy source able to be shared by a plurality of users.

6. The method as recited in claim 2, further comprising:
querying an availability period during which the energy source for shared use by multiple users is available for recharging the electrical energy store, an availability period of the energy source for shared use by multiple users on the route to be found to the destination having to be at least long enough to allow the electrical energy store to be charged for a remaining distance to the destination or for an intermediate distance to another electrical energy source.

7. The method as recited in claim 1, further comprising:
querying a scheduled immobile period of the vehicle at the electrical energy source; and
selecting a charge strategy for charging the electrical energy store based on the scheduled immobile period.

8. The method as recited in claim 1, wherein at least one of: i) an operating behavior of the vehicle, and ii) external influences on the vehicle, are taken into consideration in the search for the route.

9. A control device to implement an energy management of a vehicle moveable via an electric drive, the electric drive able to be driven by electrical energy stored in an electrical energy store, the control device configured to specify a destination, and search for a route to the destination on which an available electrical energy source which may be used to recharge the electrical energy y store is available within a minimum distance, the minimum distance corresponding to a path which the vehicle is minimally still able to drive, using the energy stored in the electrical energy store.

10. A vehicle, comprising:
an electric drive;
an electrical energy store; and
a control device to implement an energy management of a vehicle moveable via the electric drive, the electric drive able to be driven by electrical energy stored in the electrical energy store, the control device configured to specify a destination and search for a route to the destination, on which an available electrical energy source which may be used to recharge the electrical energy store is available within a minimum distance, the minimum distance corresponding to a path which the vehicle is minimally still able to drive, using the energy stored in the electrical energy store.

11. A computer-readable storage device storing a computer program having program code to implement an energy management of a vehicle movable via an electric drive, the electric drive being able to be driven by electrical energy stored in an electrical energy store, the program code, when executed by a processor, causing the processor to perform:
specifying a destination; and
searching for a route to the destination on which an available electrical energy source which may be used to recharge the electrical energy store is available within a minimum distance, the minimum distance corresponding to a path which the vehicle is minimally still able to drive, using the energy stored in the electrical energy store.

12. A computer-readable data carrier storing a computer program having program code to implement an energy management of a vehicle movable via an electric drive, the electric drive being able to be driven by electrical energy stored in an electrical energy store, the program code, when executed by a processor, causing the processor to perform:
specifying a destination; and
searching for a route to the destination on which an available electrical energy source which may be used to recharge the electrical energy store is available within a minimum distance, the minimum distance corresponding to a path which the vehicle is minimally still able to drive, using the energy stored in the electrical energy store.
